(19) United States
(12) Patent Application Publication
(10) Pub. No.: US 2014/0272703 A1
(43) Pub. Date: Sep. 18, 2014

(54) TRIBOELECTRIC CHARGE CONTROL OF TONER THROUGH MONOMER RATIO OF SHELL LATEX

(71) Applicant: XEROX CORPORATION, Norwalk, CT (US)

(72) Inventors: Padam K. ANGRA, Pittsford, NY (US); Christopher M. WOLFE, Rochester, NY (US)

(73) Assignee: XEROX CORPORATION, Norwalk, CT (US)

(21) Appl. No.: 13/840,877

(22) Filed: Mar. 15, 2013

(51) Int. Cl. G03G 9/08

(52) U.S. Cl. CPC G03G 9/0808
USPC 430/137.13

(57) ABSTRACT

Core/shell toner particles are made to have a desired triboelectric charge through control of the glass transition temperature (Tg) of the shell polymer and/or the ratio of styrene and at least one monomer for forming the polymer of the shell. The polymer is introduced onto core particles to form a shell thereon via an aggregation process.

### BACKGROUND

Numerous processes are known for producing aggregated toner particles through emulsion aggregation (EA), as illustrated in U.S. Pat. Nos. 8,221,953, 7,727,696, and 7,943,283, the disclosures of each of which are hereby incorporated by reference in their entirety.

In order to function optimally in a device, for example a xerographic engine, toner is required to exhibit the correct level of triboelectric charge. Placing charge on the particles, to enable movement and development of images via electric fields, is most often accomplished with triboelectricity. Development systems which use triboelectricity to charge toner exhibit a distribution of charges on the surfaces of the toner particles. Typically, the toner charge is optimized for each application through the attachment of suitable amounts of external additives to the particle's surface, in order to counteract the triboelectric charge inherent in the toner particles.

This approach may result in numerous drawbacks, however. For example, large amounts of additives are required to achieve the desired level of triboelectric charge. The expense and high amount of these additives may lead to increased toner costs. Additionally, while the above approach may initially guarantee a proper level of triboelectric charge for early or fresh development times, the charge typically is not maintained as the toner spends additional time mixing in the system. As toner particles spend increased amounts of time mixing in the development system, the external additives may become either imbedded in or detached from the particle's surface, thus losing their effectiveness. Toner may come to exhibit non-uniform distribution of charges on the surfaces of the toner particles. Consequently, as toner ages, the triboelectric charge inherent in the toner particle becomes dominant over the triboelectric charge produced by the additives. This non-uniform charge distribution may result in high electrostatic adhesion because of localized high surface charge densities on the particles. This shift in triboelectric charge level may result in unstable image density and other image quality defects, such as mottle or streaks.

### SUMMARY

The present disclosure provides a method for preparing toner particles having a desired triboelectric charge, comprising selecting a triboelectric charge for the toner particles, the toner particles comprising a core and a shell, selecting a styrene and at least one monomer selected from a group consisting of acrylates, butadienes, and methacrylates, obtaining a ratio of the styrene to the at least one monomer for forming a polymer, the polymer forming the shell, the ratio corresponding to the selected triboelectric charge, preparing a shell latex comprising the polymer derived from the styrene and the at least one monomer having the obtained ratio, introducing the shell latex to core particles, and aggregating to form toner particles having the shell comprised of the polymer on the core particles, and having the selected triboelectric charge.

The present disclosure additionally provides a method for preparing aggregated toner particles having a desired triboelectric charge, comprising predetermining a triboelectric charge for the aggregated toner particles based upon an application of the aggregated toner particles, the toner particles comprising a core and a shell, selecting a styrene and at least one monomer selected from a group consisting of acrylates, butadienes, and methacrylates for forming the shell, determining a necessary glass transition temperature value for a polymer derived from the selected styrene and the at least one monomer based upon the predetermined triboelectric charge, obtaining from predetermined information a ratio of the styrene to the at least one monomer necessary to form the polymer having the determined glass transition temperature value, preparing a shell latex comprising the polymer derived from the selected styrene and the at least one monomer having the obtained ratio, introducing the shell latex to aggregated core particles, and aggregating to form toner particles having the shell comprised of the polymer on the aggregated core particles, the toner particles having the predetermined triboelectric charge.

The present disclosure further provides a method of aggregating toner particles, comprising predetermining a triboelectric charge based upon an application of toner particles, the toner particles comprising a core and a shell, selecting a styrene and at least one monomer selected from the group consisting of acrylates, butadienes, and methacrylates for forming the shell, obtaining from predetermined information a ratio of the styrene to the at least one monomer necessary to achieve the toner particles having the predetermined triboelectric charge, the styrene and the at least one monomer forming a polymer, aggregating a mixture comprising a binder resin and a colorant to form the cores of the toner particles, adding a latex comprising the polymer derived from the styrene and the at least one monomer having the obtained ratio to the cores to form the shell over the cores and thereby obtain aggregated toner particles, coalescing the aggregated toner particles, and recovering the aggregated toner particles, wherein the toner particles have the predetermined triboelectric charge.

### BRIEF DESCRIPTION OF THE DRAWINGS

FIG. 1 is a graph showing a relationship between the triboelectric charge of toner particles and the glass transition temperature (Tg) of the polymer used to make the shell of the toner particles.

FIG. 2 is a graph showing a relationship between the glass transition temperature (Tg) of the polymer used to make the shell of the toner particles and the particle triboelectric charge of styrene acrylate emulsion aggregation particles K6, K7, and K5, made using a shell having a Tg of 51° C., 55° C. and 59° C., respectively.

FIG. 3 is a graph showing the relationship between toner triboelectric charge and particle triboelectric charge for styrene acrylate emulsion aggregation particles K6, K7, and K5.

FIG. 4 is a graph showing the relationship between the glass transition temperature (Tg) of the polymer used to make the shell of the toner particles and the styrene to acrylate ratio of the polymer used to make the shell of the toner particles for styrene acrylate emulsion aggregation particles K6, K7, and K5.

FIG. 5 is a graph showing the relationship between the particle triboelectric charge and the styrene to acrylate ratio of the polymer used to make the shell of the toner particles for styrene acrylate emulsion aggregation particles K6, K7, and K5.

### EMBODIMENTS

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

“Optional” or “optionally” refer, for example, to instances in which subsequently described circumstances may or may not occur, and include instances in which the circumstance occurs and instances in which the circumstance does not occur.

The phrases “one or more” and “at least one” refer, for example, to instances in which one of the subsequently described circumstances occurs, and to instances in which more than one of the subsequently described circumstances occurs.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

In accordance with the present disclosure, methods for making core/shell toner particles in which the toner particles have a predetermined desired triboelectric charge are disclosed.

It has been discovered by the present inventors that the triboelectric charge of a core/shell toner particle in which the shell is composed of a styrene-monomer derived polymer is correlated with the glass transition temperature (Tg) of the polymer, which is correlated with the ratio of the styrene to the monomer used to make the polymer. This makes the glass transition temperature of the polymer and/or the styrene to monomer ratio an effective tuning mechanism for the optimization of toner triboelectric charge levels, without reliance on external additives.

The present disclosure demonstrates that by controlling the monomer content used to make the shell polymer, the Tg of the shell may be controlled, and thus the triboelectric charge of the toner particle may be readily dialed to a predetermined, desired level, and this level may be substantially maintained throughout the cycle of the toner through a xerographic engine, due to the charge not being reliant on the use of external additives. The disclosed methods allow for a more controllable level of triboelectric charge of the toner particles.

The toners herein have a core/shell structure. The shell of the toner is substantially responsible for controlling the particles' triboelectric charge, at least so long as the shell adequately covers the core of the particles, and thus the shell is also the most significant contributing factor to the triboelectric charge of the end toner.

### Toner Core

The core of the toner may be composed of any suitable materials, but is typically composed at least of polymeric binder and colorant, often also with at least some wax.

As a binder for the core, the binder may be derived from monomers. Suitable monomers include styrenes, acrylates, methacrylates, butadienes, isoprenes, acrylic acids, methacrylic acids, acrylonitriles, combinations thereof, and the like.

Suitable toner resins for the binder may include thermoplastic resins such as vinyl resins or styrene resins, and polyesters. Suitable thermoplastic resins include styrene methacrylate; polyolefins; styrene acrylates, such as PSB-2700 obtained from Hercules-Sanyo Inc.; styrene butadienes; crosslinked styrene polymers; epoxies; polyurethanes; vinyl resins, including homopolymers or copolymers of two or more vinyl monomers; and polymeric esterification products of a dicarboxylic acid and a diol comprising a diphenol. Other suitable vinyl monomers include styrene; p-chlorostyrene; unsaturated mono-olefins such as ethylene, propylene, butylene, isobutylene, and the like; saturated mono-olefins such as vinyl acetate, vinyl propionate, and vinyl butyrate; vinyl esters such as esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, butyl methacrylate; acrylonitrile; methacrylonitrile; acrylamide; poly(styrene-alkyl acrylate); poly(styrene-1,3-diene); poly(styrene-alkyl methacrylate); poly(styrene-alkyl acrylate-acrylic acid); poly(styrene-1,3-diene-acrylic acid); poly(styrene-alkyl methacrylate-acrylic acid); poly(alkyl methacrylate-alkyl acrylate); poly(alkyl methacrylate-aryl acrylate); poly(aryl methacrylate-alkyl acrylate); poly(alkyl methacrylate-acrylic acid); poly(styrene-alkyl acrylate-acrylonitrile-acrylic acid); poly(styrene-1,3-diene-acrylonitrile-acrylic acid); poly(alkyl acrylate-acrylonitrile-acrylic acid); poly(styrene-butadiene); poly(methylstyrene-butadiene); poly(methyl methacrylate-butadiene); poly(ethyl methacrylate-butadiene); poly(propyl methacrylate-butadiene); poly(butyl methacrylate-butadiene); poly(methyl acrylate-butadiene); poly(ethyl acrylate-butadiene); poly(propyl acrylate-butadiene); poly(butyl acrylate-butadiene); poly(styrene-isoprene); poly(methylstyrene-isoprene); poly(methyl methacrylate-isoprene); poly(ethyl methacrylate-isoprene); poly(propyl methacrylate-isoprene); poly(butyl methacrylate-isoprene); poly(methyl acrylate-isoprene); poly(ethyl acrylate-isoprene); poly(propyl acrylate-isoprene); poly(butyl acrylate-isoprene); poly(styrene-propyl acrylate); poly(styrene-butyl acrylate); poly(styrene-butadiene-acrylic acid); poly(styrene-butadiene-methacrylic acid); poly(styrene-butadiene-acrylonitrile-acrylic acid); poly(styrene-butyl acrylate-acrylic acid); poly(styrene-butyl acrylate-methacrylic acid); poly(styrene-butyl acrylate-acrylononitrile); poly(styrene-butyl acrylate-acrylonitrile-acrylic acid); poly(styrene-butadiene); poly(styrene-isoprene); poly(styrene-butyl methacrylate); poly(styrene-butyl acrylate-acrylic acid); poly(styrene-butyl methacrylate-acrylic acid); poly(butyl methacrylate-butyl acrylate); poly(butyl methacrylate-acrylic acid); poly(acrylonitrile-butyl acrylate-acrylic acid); and combinations thereof. The polymers may be block, random, or alternating copolymers. In addition, crosslinked resins, including polymers, copolymers, and homopolymers of styrene polymers, may be selected.

The binder polymer is capable of being formed into a latex, so that the polymer can be readily used in known emulsion aggregation processes to form the core particles via aggregation. Following aggregation, core particles typically have a size of from about 4 to about 15 microns.

In addition to the resin binder, the core particles may also contain a wax, either a single type of wax or a mixture of two or more different waxes. A single wax can be added to toner formulations, for example, to improve particular toner properties, such as toner particle shape, presence and amount of wax on the toner particle surface, charging and/or fusing characteristics, gloss, stripping, offset properties, and the like. Alternatively, a combination of waxes may be added to provide multiple properties to the toner composition.

Suitable waxes include natural vegetable waxes, natural animal waxes, mineral waxes, synthetic waxes, and functionalized waxes. Suitable natural vegetable waxes include carnauba wax, candelilla wax, rice wax, sumacs wax, jojoba oil, Japan wax, and bayberry wax. Suitable natural animal waxes include beeswax, punic wax, lanolin, lac wax, shellac wax, and spermaceti wax. Suitable mineral-based waxes include paraffin wax, microcrystalline wax, montan wax, ozokerite wax, ceresin wax, petrolatum wax, and petroleum wax. Suitable synthetic waxes include Fischer-Tropsch wax; acrylate wax; fatty acid amide wax; silicone wax; polytetrafluoroethylene wax; polyethylene wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, diglyceryl distearate, dipropyleneglycol distearate, and triglyceryl tetrastearate; sorbitan higher fatty acid ester waxes, such as sorbitan monostearate; and cholesterol higher fatty acid ester waxes, such as cholesteryl stearate; polypropylene wax; and mixtures thereof.

The wax may be selected from polypropylenes and polyethylenes commercially available from Allied Chemical and Baker Petrolite (for example POLYWAX™ polyethylene waxes from Baker Petrolite), wax emulsions available from Michelman Inc. and the Daniels Products Company, EPOLENE N-15 commercially available from Eastman Chemical Products, Inc., VISCOL 550-P, a low weight average molecular weight polypropylene available from Sanyo Kasei K.K., and similar materials. The commercially available polyethylenes usually possess a molecular weight (Mw) of from about 500 to about 2,000, such as from about 1,000 to about 1,500, while the commercially available polypropylenes used have a molecular weight of from about 1,000 to about 10,000. Examples of functionalized waxes include amines, amides, imides, esters, quaternary amines, carboxylic acids or acrylic polymer emulsion, for example, JONCRYL 74, 89, 130, 537, and 538, all available from Johnson Diversey, Inc., and chlorinated polyethylenes and polypropylenes commercially available from Allied Chemical and Petrolite Corporation and Johnson Diversey, Inc. The polyethylene and polypropylene compositions may be selected from those illustrated in British Pat. No. 1,442,835, the entire disclosure of which is totally incorporated herein by reference.

The core particles may contain the wax in an amount of, for example, from about 1 to about 25 wt % of the core particles, such as from about 3 to about 15 wt %, or from about 5 to about 20 wt %, or from about 5 to about 12 wt %.

The core particles also desirably contain at least one colorant. Suitable colorants or pigments include pigment, dye, mixtures of pigment and dye, mixtures of pigments, mixtures of dyes, and the like. For simplicity, the term “colorant” refers to colorants, dyes, pigments, and mixtures, unless specified as a particular pigment or other colorant component.

In general, suitable colorants may include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF), and carbon blacks such as REGAL 330 (Cabot), Carbon Black 5250 and 5750 (Columbian Chemicals), and the like, and mixtures thereof.

Additional colorants may include pigments in water-based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226), and the like, and mixtures thereof. Other water based colorant dispersions include those commercially available from Clariant, for example, HOSTAFINE Yellow GR, HOSTAFINE Black T and Black TS, HOSTAFINE Blue B2G, HOSTAFINE Rubine F6B, and magenta dry pigment such as Toner Magenta 6BVP2213 and Toner Magenta EO2 that may be dispersed in water and/or surfactant prior to use.

Additional suitable colorants may include magnetites, such as Mobay magnetites MO8029, MO8960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like, and mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI-60710, CI Dispersed Red 15, diazo dye identified in the Color Index as CI-26050, CI Solvent Red 19, and the like, and mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like, and mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components, may also be selected as pigments.

The colorant, such as carbon black, cyan, magenta, and/or yellow colorant, is incorporated in an amount sufficient to impart the desired color to the toner. In general, pigment or dye is employed in an amount ranging from about 1 to about 35 wt % of the particles on a solids basis, such as from about 5 to about 25 wt %, or from about 5 to about 15 wt %.

Colorants, waxes, and other additives used to form toner compositions may be in dispersions that include surfactants.

One, two, or more surfactants may be used in the latexes and dispersions. The surfactants may be selected from ionic surfactants and nonionic surfactants. Anionic surfactants and cationic surfactants are encompassed by the term “ionic surfactants.” The surfactant may be present in an amount of from about 0.01 to about 5 wt % of the toner composition, such as from about 0.75 to about 4 wt %, or from about 1 to about 3 wt %.

Suitable nonionic surfactants include methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™, ANTAROX 897™, and a block copolymer of polyethylene oxide and polypropylene oxide, including those commercially available as SYNPERONIC PE/F, such as SYNPERONIC PE/F 108.

Suitable anionic surfactants include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be used.

### Aggregating Agents

Any aggregating agent capable of causing complexation may be used in forming toners of the present disclosure. Both alkali earth metal and transition metal salts can be utilized as aggregating agents. Alkali (II) salts can be selected to aggregate latex resin colloids with a colorant to enable the formation of a toner composite. Such salts include beryllium chloride, beryllium bromide, beryllium iodide, beryllium acetate, beryllium sulfate, magnesium chloride, magnesium bromide, magnesium iodide, magnesium acetate, magnesium sulfate, calcium chloride, calcium bromide, calcium iodide, calcium acetate, calcium sulfate, strontium chloride, strontium bromide, strontium iodide, strontium acetate, strontium sulfate, barium chloride, barium bromide, barium iodide, and optionally combinations thereof. Examples of transition metal salts or anions suitable as aggregating agent include acetates of vanadium, niobium, tantalum, chromium, molybdenum, tungsten, manganese, iron, ruthenium, cobalt, nickel, copper, zinc, cadmium, or silver; acetoacetates of vanadium, niobium, tantalum, chromium, molybdenum, tungsten, manganese, iron, ruthenium, cobalt, nickel, copper, zinc, cadmium, or silver; sulfates of vanadium, niobium, tantalum, chromium, molybdenum, tungsten, manganese, iron, ruthenium, cobalt, nickel, copper, zinc, cadmium, or silver; and aluminum salts such as aluminum acetate, aluminum halides such as polyaluminum chloride, combinations thereof, and the like.

### Shell

As the shell of the toner particles, the shell is desirably comprised solely of polymer derived from styrene and at least one monomer selected from acrylates, methacrylates, and butadienes. The shell is thus desirably free of other polymers and other additives.

The monomers are desirably formed into polymer latex, for example by emulsion polymerization.

Exemplary monomers for the monomer package to be reacted with styrene include alkyl acrylate, 1,3-diene, alkyl methacrylate, alkyl acrylate-acrylic acid, 1,3-diene-acrylic acid, alkyl methacrylate-acrylic acid, alkyl acrylate-acrylonitrile-acrylic acid, 1,3-diene-acrylonitrile-acrylic acid, butadiene, isoprene, propyl acrylate, butyl acrylate, butadiene-acrylic acid, butadiene-methacrylic acid, butadiene-acrylonitrile-acrylic acid, butyl acrylate-acrylic acid, butyl acrylate-methacrylic acid, butyl acrylate-acrylononitrile, butyl acrylate-acrylonitrile-acrylic acid, butyl methacrylate, butyl acrylate-acrylic acid, butyl methacrylate-acrylic acid, and combinations thereof, wherein alkyl is defined as a C₁-C₂₀ carbon chain, linear or branched, optimally substituted with heteroatoms.

The latex polymer may include at least one polymer derived from styrene and the at least one monomer. Exemplary polymers for the shell include poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(styrene-alkyl acrylate-acrylonitrile-acrylic acid), poly(styrene-1,3-diene-acrylonitrile-acrylic acid), poly(styrene-butadiene), poly(methylstyrene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), and combinations thereof. The polymers may be block, random, or alternating polymers.

For example, styrene and butyl acrylate may be used to form the copolymer for the shell.

The shell polymer may have a glass transition temperature of from about 30° C. to about 80° C., such as from about 40° C. to about 70° C. Glass transition temperature is desirably measured by a differential scanning calorimeter.

The shell latex containing the polymer derived from the styrene and the at least one monomer may be applied to the cores by any method within the purview of the art. However, application via aggregation is most preferred. The shell may be applied until the desired final size of the toner particles is achieved, such as from about 5 to about 15 microns, such as from about 6 microns to about 10 microns.

Most desirably, the shell is applied until the core is covered by at least one, but desirably at least two, monolayers of the polymer, to ensure sufficient coverage of the core. The monolayer is a composition desirably consisting entirely of the shell polymer. Most desirably, there are at least at least two full layers of the polymer completely circulating the core. The monolayer may have a thickness from about 0.2 microns to about 3 microns, such as from about 0.5 microns to about 1.5 microns. This thickness also helps ensure that the contents of the core do not protrude onto the surface of the end toner particle, as this can adversely affect the toner particle's triboelectric charge.

By controlling the composition of the polymer of the shell, for example by selecting the styrene and the at least one monomer to form the polymer and the ratio of the styrene to the at least one monomer, the glass transition temperature of the shell polymer and/or the triboelectric charge of the end toner particles may be controlled. For example, if a styrene butyl acrylate copolymer is used to form the shell, the glass transition temperature of the shell polymer may be increased or decreased by controlling the ratio of the styrene to the butyl acrylate monomer used to make the polymer. Specifically, by increasing the concentration of the styrene in the monomer package, and thus similarly decreasing the concentration of butyl acrylate in the monomer package, the glass transition temperature of the shell and end particle may be increased. Conversely, by decreasing the concentration of styrene in the monomer package, and thus similarly increasing the concentration of butyl acrylate in the monomer package, the glass transition temperature of the shell and end particle may be decreased.

The toner particle may have a triboelectric charge of from about −15 microcoulombs/gram to about −80 microcoulombs/gram, such as from about −30 microcoulombs/gram to about −50 microcoulombs/gram. Triboelectric charge is desirably measured by the total blow-off method, which is in the purview of those skilled in the art.

### Methods

Toner particles may be formed by emulsion aggregation methods where the resin and other components of the toner are used in the form of emulsions, toner particles are aggregated, coalesced, optionally washed and dried, and recovered.

Toner core particles may be prepared by combining a resin with an optional wax, an optional surfactant, an optional colorant, an optional initiator, an optional aggregating agent, and additional optional additives to a reactor to form a mixture, and aggregating the mixture to form core aggregates. A shell resin then may be added to the core aggregates to form toner particles having a shell.

The reactor may additionally include a jacket. During the aggregation process, the jacket temperature may be set to a temperature that is about 1° C. to about 5° C. higher than the glass transition temperature of the core binder latex used in the aggregation mixture, such as from about 2.4° C. to about 2.6° C. higher than the glass transition temperature of the latex used in the aggregation mixture. During shell addition, the jacket temperature may be set to a temperature that is about 1° C. to about 5° C. higher than the glass transition temperature of the shell latex, such as from about 3.4° C. to about 3.6° C. higher than the glass transition temperature of the shell. During coalescence, the jacket temperature may be set to a temperature that is about 25° C. to about 45° C. higher than the glass transition temperature of the shell latex, such as from about 30° C. to about 40° C. higher than the glass transition temperature of the shell.

After the shell is applied to the toner particles have reached their desired size, the toner particles may be coalesced and recovered by, for example, heating the mixture or by adding an acid to the mixture, followed by wet sieving, washing, and drying.

The toner particles may then be mixed with one or more external additives, as known in the art, to obtain a blended toner composition containing blended toner particles.

As a result of the above described method, the Tg of the shell may be controlled through control of the monomer content of the shell polymer, and in turn the triboelectric charge of the core/shell particles, and thus triboelectric charge of the end toner particles, may be reliably controlled.

The triboelectric charge of a toner particle may be manipulated by controlling the Tg of the shell polymer, and thus by controlling the ratio of styrene to the at least one monomer used in making the polymer of the shell.

In general, for the above listed shell polymers, an increase in the Tg of the shell polymer is correlated with an increase in the magnitude of triboelectric charge of a toner particle. Conversely, a decrease in the Tg of the shell polymer is correlated with a decrease in the magnitude of triboelectric charge of a toner particle.

The Tg of any styrene and at least one monomer package used to make the shell polymer may be evaluated in advance to collect data on the relationship between a styrene-monomer ratio and Tg. Similarly, data may be collected in advance on the relationship between a styrene-monomer ratio, or the Tg of the polymer from the styrene and monomer package, and triboelectric charge of the derived toner particles.

Imaging devices and xerographic devices operate to require a specific triboelectric charge value of toner particles, such triboelectric charge values being known in the art. As a result of the above described method, a toner having the desired (or required) triboelectric charge value for the device may be readily designed. For example, knowing the triboelectric charge the toner must exhibit, one can use stored data on the pre-determined relationships discussed above to select the styrene and monomer package and ratios thereof to achieve the needed triboelectric charge. Or, one could also pre-select the styrene and at least one monomer package, and then use stored data to determine the ratio of the materials needed to achieve a particle with the needed triboelectric charge. The stored data may be correlated through Tg of the polymer from the monomers, as discussed above. The monomer package may then be used to form a polymer latex that is used as a shell forming material in the production of an end toner particle having the desired triboelectric charge value.

Data on the relationships discussed above that can be stored for look up may be gathered via techniques of evaluation and measurement known in the art. The stored data may then be accessed through any suitable means, although storing in computer accessible databases is most desirable. The data may be accessed by inputting certain terms such as triboelectric charge and monomer materials, and having the computer search the stored data and return the monomers to use, and/or the ratio to use in making the shell latex.

As a result of the above described method, a toner having the desired triboelectric charge value may be readily designed by selecting a monomer package for the toner based on previously gathered data on styrene-monomer ratio and Tg. This monomer package may then be used to form a polymer latex that may then be used as a shell latex in the production of a toner particle having the desired triboelectric charge value.

The characteristics of the toner particles may be determined by any suitable technique and apparatus and are not limited to the instruments and techniques indicated hereinabove.

### External Additives

Once a toner particle having the desired triboelectric charge value is produced, the triboelectric charge of the end toner may be achieved by the use of minimal amounts of desired or required external additives. Even with the addition of additives, the triboelectric charge of the toner particle remains correlated with the end toner triboelectric charge, as shown in FIG. 3.

Suitable external additives include any additive that enhances the properties of the toner composition. For example, the toner may include positive or negative charge control agents in an amount of from about 0.1 to about 10 wt % of the toner, such as from about 1 to about 5 wt %, or from about 1 to about 3 wt %. Examples of suitable charge control agents include quaternary ammonium compounds inclusive of alkyl pyridinium halides; bisulfates; alkyl pyridinium compounds, including those disclosed in U.S. Pat. No. 4,298,672, the entire disclosure of which is totally incorporated herein by reference; organic sulfate and sulfonate compositions, including those disclosed in U.S. Pat. No. 4,338,390, the entire disclosure of which is totally incorporated herein by reference; cetyl pyridinium tetrafluoroborates; distearyl dimethyl ammonium methyl sulfate; aluminum salts such as BONTRON E88™, or zinc salts such as E-84 (Orient Chemical); combinations thereof, and the like.

Other additives include organic spacers, such as polymethylmethacrylate (PMMA). The organic spacer may have a volume average diameter of from about 300 to about 600 nm, such as from about 300 to about 400 nm, or from about 350 to about 450 nm, such as 300 nm, 350 nm, 400 nm, 450 nm, or 500 nm.

Other additives include surface additives, color enhancers, and the like. Surface additives that can be added to the toner compositions after washing or drying include, for example, metal salts, metal salts of fatty acids, colloidal silicas, metal oxides, strontium titanates, combinations thereof, and the like, which additives may each be present in an amount of from about 0.1 to about 10 wt % of the toner particles, such as from about 0.5 to about 7 wt %. Examples of such additives include, for example, RY 50 (Silica), STT100H (Titania), TAF500-T15 (Titania), and U-add (Unilin wax), as well as those disclosed in U.S. Pat. Nos. 3,590,000; 3,720,617; 3,655,374; and 3,983,045, the entire disclosures of which are totally incorporated herein by reference. Other additives include zinc stearate and AEROSIL R972® available from Degussa. The coated silicas of U.S. Pat. Nos. 6,190,815 and 6,004,714, the entire disclosures of which are totally incorporated herein by reference, may also be selected in amounts, for example, of from about 0.05 to about 5 wt % of the toner particles, such as from about 0.1 to about 2 wt %. These additives may be added during the aggregation or blended into the formed toner product.

### Imaging

Toners in accordance with the present disclosure may be used in a variety of imaging or xerographic devices including printers, copy machines, and the like. The toners generated in accordance with the present disclosure are excellent for imaging processes, especially xerographic processes, and are capable of providing high quality colored images with excellent image resolution, acceptable signal-to-noise ratio, and image uniformity. Further, toners of the present disclosure may be selected for electrophotographic imaging and printing processes such as digital imaging systems and processes.

Any known type of image development system may be used in an image developing device to form images with the toner set described herein, including, for example, magnetic brush development, single component development (SCD), two component development (TCD), hybrid scavengeless development (HSD), and the like.

### EXAMPLES

Three styrene EA toner particles are provided, K6, K7, and K5. K6 is produced with a shell latex Tg of 51° C. and derived from a monomer composition of 75.6% styrene and 23.5% n-butyl-acrylate (nBA). K7 is produced with a shell latex Tg of 55° C. and derived from a monomer composition of 79.3% styrene and 20.7% nBA. K5 is produced with a shell latex Tg of 59° C. and derived from a monomer composition of 81.7% styrene and 18.3% nBA. K6, K7, and K5 each include 11% wax and 6% carbon black REGAL 330 (Cabot) colorant in the core particles. External additives used to make example toners form K5, K6, and K7 particles include RY 50 (Silica) at 1.75 wt %, STT100H (Titania) at 0.76 wt %, TAF500-T15 (Titania) at 0.32 wt %, and U-add (Unilin wax) at 0.90 wt %. The toner particle and external additives were mixed in a 600 Liter Henschel blender at 750 rpm for 5.5 minutes.

After mixing the materials, the triboelectric charge was measured by the total blow-off method, a method primarily used for the measurement of the charge of dual component xerographic developer, which is in the purview of those skilled in the art. In the blow-off method, the charged developer is placed in a Faraday cage and the toner particles are blown off the carrier surface using an air stream. The charge of the blown off toner particles is characterized using an electrometer. The mass of the blown off toner particles is measured by using a balance. The triboelectric charge is typically expressed as the ratio of charge to mass (q/m).

FIG. 1 shows a correlation between the triboelectric charge of styrene acrylate emulsion aggregation particles and the Tg of the particles' shell polymer. The graph in FIG. 1 illustrates that as the shell Tg is increased, there is an increase in the magnitude of particle triboelectric charge, all other components being held constant. For a toner particle having a shell Tg of 51° C., a particle triboelectric charge of approximately negative 38 microcoulombs per gram is observed, and for a toner particle having a shell Tg of 59° C., a particle triboelectric charge of approximately negative 47 microcoulombs per gram is observed. The same trend is observed with toner particles having both 9% and 11% wax levels, confirming that the core particles are adequately covered by the shell.

FIG. 2 further illustrates the correlation between the triboelectric charge of styrene acrylate emulsion particles and the Tg of the particle's shell. The correlation may be substantially linear, as shown in FIG. 2. The graph in FIG. 2 illustrates that as the shell Tg is increased, there is an increased magnitude of particle triboelectric charge, all other components being held constant.

FIG. 3 illustrates a correlation between the particle triboelectric charge and the toner triboelectric charge. The correlation may be substantially linear, as shown in FIG. 3. The graph in FIG. 3 illustrates that the particle triboelectric charge can be used to control the end toner triboelectric charge.

FIG. 4 illustrates a correlation between the glass transition temperature (Tg) of the polymer used to make the shell of the toner particles and the styrene to acrylate ratio of the polymer used to make the shell of the toner particles. The correlation may be substantially linear, as shown in FIG. 4. The graph in FIG. 4 illustrates that the styrene to acrylate ratio of the polymer used to make the shell of the toner particles can be used to control the glass transition temperature (Tg) of the polymer used to make the shell of the toner particles.

FIG. 5 illustrates a correlation between the particle triboelectric charge and the styrene to acrylate ratio of the polymer used to make the shell of the toner particles. The correlation may be substantially linear, as shown in FIG. 5. The graph in FIG. 5 illustrates that the styrene to acrylate ratio of the polymer used to make the shell of the toner particles can be used to control the particle triboelectric charge.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for preparing toner particles having a desired triboelectric charge, comprising:
selecting a triboelectric charge for the toner particles, the toner particles comprising a core and a shell;
selecting a styrene and at least one monomer selected from the group consisting of acrylates, butadienes, and methacrylates;
obtaining a ratio of the styrene to the at least one monomer for forming a polymer, the polymer forming the shell, the ratio corresponding to the selected triboelectric charge;
preparing a shell latex comprising the polymer derived from the styrene and the at least one monomer having the obtained ratio;
introducing the shell latex to core particles; and
aggregating to form toner particles having the shell comprised of the polymer on the core particles, and having the selected triboelectric charge.

2. The method of claim 1, wherein the core comprises a binder and a colorant.

3. The method of claim 2, wherein the colorant comprises a carbon black pigment.

4. The method of claim 1, further comprising:
determining a jacket temperature for introducing the shell latex to the core particles based on the obtained ratio of the styrene to the at least one monomer.

5. The method of claim 1, wherein the core further comprises a wax.

6. The method of claim 1, wherein the at least one monomer comprises butyl acrylate.

7. The method of claim 1, wherein the ratio of the styrene to the at least one monomer is obtained from stored data regarding the relationship between triboelectric charge and the ratio for the selected styrene and the at least one monomer.

8. The method of claim 1, wherein the triboelectric charge of the toner particles is from −15 microcoulombs/gram to −80 microcoulombs/gram.

9. A method for preparing aggregated toner particles having a desired triboelectric charge, comprising:
predetermining a triboelectric charge for the aggregated toner particles based upon an application of the aggregated toner particles, the toner particles comprising a core and a shell;
selecting a styrene and at least one monomer selected from the group consisting of acrylates, butadienes, and methacrylates for forming the shell;
determining a necessary glass transition temperature value for a polymer derived from the selected styrene and the at least one monomer based upon the predetermined triboelectric charge;
obtaining from predetermined information a ratio of the styrene to the at least one monomer necessary to form the polymer having the determined glass transition temperature value;
preparing a shell latex comprising the polymer derived from the selected styrene and the at least one monomer having the obtained ratio;
introducing the shell latex to aggregated core particles; and
aggregating to form toner particles having the shell comprised of the polymer on the aggregated core particles, the toner particles having the predetermined triboelectric charge.

10. The method of claim 9, wherein the ratio of the styrene to the at least one monomer is obtained from stored data regarding the relationship between triboelectric charge and the ratio for the selected styrene and the at least one monomer.

11. The method of claim 9, wherein the triboelectric charge of the aggregated toner particles is related to the glass transition temperature of the shell.

12. The method of claim 9, wherein the ratio of the styrene to the at least one monomer is obtained by correlating the determined glass transition temperature value to the predetermined triboelectric charge from stored data, and subsequently obtaining the ratio of the styrene to the at least one monomer from stored data regarding the relationship between the glass transition temperature value and the ratio of the styrene to the at least one monomer for the selected styrene and the at least one monomer.

13. The method of claim 9, wherein the shell polymer is selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(styrene-alkyl acrylate-acrylonitrile-acrylic acid), poly(styrene-1,3-diene-acrylonitrile-acrylic acid), poly(styrene-butadiene), poly(methylstyrene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), and combinations thereof.

14. The method of claim 9, further comprising:
determining a jacket temperature for introducing the shell latex to aggregated core particles based on the obtained ratio of the styrene to the at least one monomer.

15. The method of claim 8, wherein the at least one monomer comprises butyl acrylate.

16. The method of claim 9, wherein the core comprises binder and a colorant.

17. The method of claim 16, wherein the colorant comprises carbon black pigment.

18. The method of claim 9, wherein the core further comprises a wax.

19. The method of claim 9, wherein the triboelectric charge of the toner particles is from −15 microcoulombs/gram to −80 microcoulombs/gram.

20. The method of claim 9, wherein the glass transition temperature value is from 30° C. to 80° C.

21. A method of aggregating toner particles, comprising:
predetermining a triboelectric charge based upon an application of toner particles, the toner particles comprising a core and a shell;
selecting a styrene and at least one monomer selected from the group consisting of acrylates, butadienes, and methacrylates for forming the shell;
obtaining from predetermined information a ratio of the styrene to the at least one monomer necessary to achieve the toner particles having the predetermined triboelectric charge, the styrene and the at least one monomer forming a polymer;
aggregating a mixture comprising a binder resin and a colorant to form the cores of the toner particles;
adding a latex comprising the polymer derived from the styrene and the at least one monomer having the obtained ratio to the cores to form the shell over the cores and thereby obtain aggregated toner particles;
coalescing the aggregated toner particles; and
recovering the aggregated toner particles, wherein the toner particles have the predetermined triboelectric charge.

22. The method of claim 21, wherein the shell polymer is selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(styrene-alkyl acrylate-acrylonitrile-acrylic acid), poly(styrene-1,3-diene-acrylonitrile-acrylic acid), poly(styrene-butadiene), poly(methylstyrene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), and combinations thereof.

23. The method of claim 21, wherein the ratio of the styrene to the at least one monomer is obtained from stored data regarding the relationship between triboelectric charge and the ratio for the selected styrene and the at least one monomer.
